(19) United States
(12) Patent Application Publication
(10) Pub. No.: US 2007/0268394 A1
(43) Pub. Date: Nov. 22, 2007

(54) Camera, image output apparatus, image output method, image recording method, program, and recording medium

(76) Inventors: Osamu Nonaka, Sagamihara-shi (JP); Keiji Kunishige, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/801,033

(22) Filed: May 9, 2007

(30) Foreign Application Priority Data
May 15, 2006 (JP) 2006-135315
Mar. 19, 2007 (JP) 2007-070498

(51) Int. Cl. H04N 5/222

(52) U.S. Cl. 348/333.12

(57) ABSTRACT

Disclosed is a camera which can output an image to an external display device, and creates an image (size-changed image) with an aspect ratio according to the external display device from a part of a shot image. The size-changed image can be created in such a way as to include, for example, the face of a subject. The size-changed image can be created in consideration of, for example, the posture (vertical/horizontal) of the camera at the time of shooting. For example, the camera can be provided with a display part to display regional information indicating the region of the size-changed image.

### CROSS REFERENCES TO RELATED APPLICATION

This application is based upon and claims the benefit of priority from prior Japanese Patent Application Nos. 2006-135315 filed on May 15, 2006 and 2007-070498 filed on Mar. 19, 2007, the entire contents of which are incorporated herein by reference.

### BACKGROUND OF THE INVENTION

1. Field of the Invention

The present invention relates to a camera and an image output apparatus which output an image corresponding to the aspect ratio of an external display device.

2. Description of the Related Art

Shot images captured by a digital camera are not only printed like those of a conventional film camera for appreciation, but also displayed on a TV or the monitor of a personal computer for another appreciation style.

One of problems in viewing shot images on a TV or the like is such that if an image of vertical composition shot by a camera is displayed directly on the screen, the vertical image is displayed horizontally. As a solution to this problem, there has been proposed a camera which detects from the shooting posture if the shot is of vertical composition or horizontal composition, and matches the shooting condition with the playback condition to reflect the matching result at the time of playback (Japanese Patent Application Laid-Open No. 2003-60940).

As home environments for playback of digital contents are being set up, it is expected that opportunities to enjoy an image with a large-screen TV increase. The number of large-screen TVs with a high definition (HD) quality having a horizontally-long screen with an aspect ratio is 16:9 are increasing. On the other hand, the image pickup devices of cameras have an aspect ratio of 4:3 suitable for prints. This difference in aspect ratio causes a problem. As a solution to this problem, there has been proposed a camera which can change over the aspect ratio (Japanese Patent Application Laid-Open No. H8-37611).

When a still image of vertical shot is reproduced on a large-screen TV with its orientation changed by 90 degrees, large non-display portions (blank areas) are created on the right and left sides. There is a proposal which effectively uses the blank areas on the right and left side of a wide screen (Japanese Patent Application Laid-Open No. 2006-109360). This Japanese Patent Application Laid-Open No. 2006-109360 discloses a technique to image display control for displaying two images of vertical composition side by side.

### BRIEF SUMMARY OF THE INVENTION

According to the present invention, a camera capable of outputting an image to an external display device creates an image (size-changed image) with an aspect ratio according to the external display device from a part of a captured image.

The size-changed image can be created in such a way as to include, for example, the face of a subject.

The size-changed image can be created in consideration of, for example, the posture (vertical/horizontal) of the camera at the time of capturing.

For example, the camera can be provided with a display part to display regional information indicating the region of the size-changed image.

As an exemplary structure of the present invention, a camera comprises an output part that outputs a recorded image to an external display device; an image pickup device that captures a subject image; a size change part that creates a size-changed image which is a partial image of a full image whose captured area is an entire capturing face of the image pickup device according to a difference between an aspect ratio of the full image and an aspect ratio of the external display device; and a control part that controls to record the full image and the size-changed image.

The present invention can be understood as an invention of an image output apparatus, and inventions of an image recording method, an image output method, and a recording medium storing a computer program.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a general block diagram of a camera 1 to which the invention is adapted according to a first embodiment;

FIGS. 2A and 2B are diagrams showing one example of scenes where a user views images according to the first embodiment;

FIG. 3 is a diagram showing a scene of shooting a vertical composition according to the first embodiment;

FIGS. 4A to 4C are diagrams showing various images to be displayed on a wide-screen TV 21 according to the first embodiment;

FIGS. 5A to 5H are diagrams showing the relationships between the sizes of images to be displayed on the screen of the TV 21 and pixels to be used in displaying the corresponding images according to the first embodiment;

FIG. 6 is a flowchart illustrating procedures of an image output process according to the first embodiment;

FIG. 7 is a flowchart illustrating procedures of an image recording process of also recording a size-changed image at the time of shooting according to the first embodiment;

FIG. 8 is a flowchart illustrating procedures of an image synthesizing process according to the first embodiment;

FIG. 9 is a diagram showing an image to be displayed on the TV 21 according to the first embodiment;

FIGS. 10A and 10B are diagrams showing two examples of a monitor image to be displayed on a display part at the time of shooting according to a second embodiment;

FIGS. 11A and 11B are diagrams showing follow-up of a frame 23b at the time of changing the composition to the second embodiment; and

FIG. 12 is a flowchart illustrating procedures of a shooting process according to the second embodiment.

### DETAILED DESCRIPTION OF THE PREFERRED EMBODIMENTS

Preferred embodiments of the invention are described below with reference to the accompanying drawings.

### First Embodiment

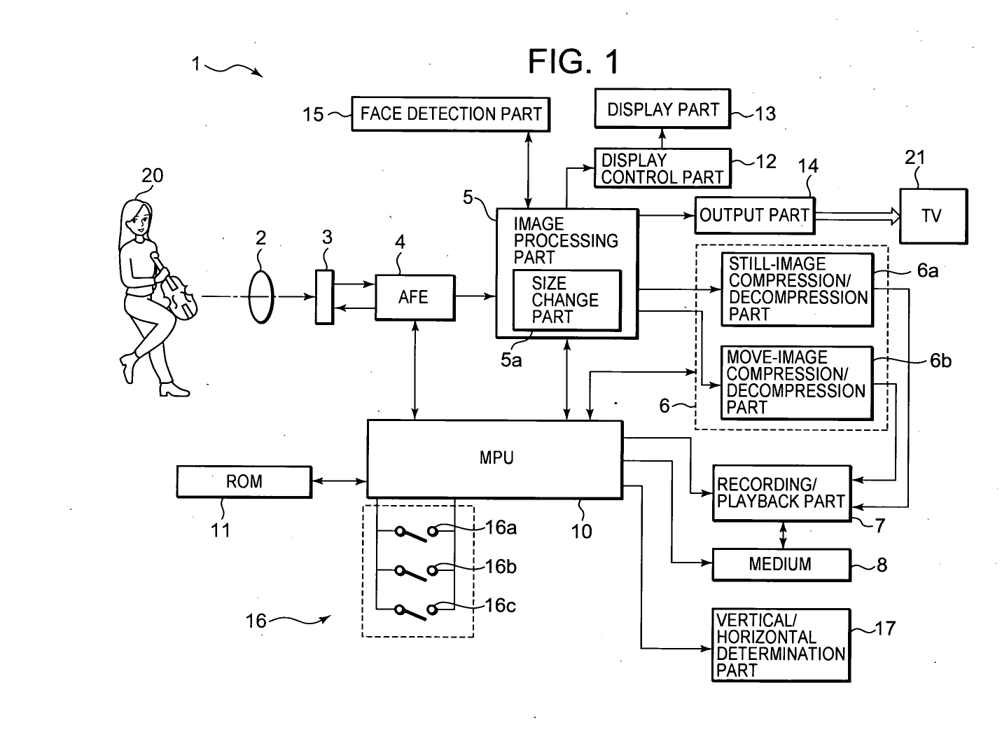

FIG. 1 is a general block diagram of a camera 1 to which the invention is applied. The camera 1 is provided with a lens part 2, an image pickup device 3, an analog front end (hereinafter “AFE”) part 4, an image processing part 5, a compression/decompression part 6, a recording/playback part 7, and a medium 8. The lens part 2 forms the image of an input subject 20 onto the image pickup device 3. The image pickup device 3, which comprises a CCD or CMOS, converts the formed subject image to an electric signal. The AFE part 4 converts an analog signal output from the image pickup device 3 to a digital image signal to be input to the image processing part 5. The AFE part 4 has a function of choosing a proper signal from signals output from the image pickup device 3, and can extract only limited pixel data from the entire light-receiving face.

The image processing part 5 performs various processes, such as color correction, smoothing and contrast enhancement, on image data. The image processing part 5 is provided with a size change part 5a. The size change part 5a creates an image (called “a size-changed image”), which has a size and aspect ratio different from that of an original image, at the time of capturing and at the time of playback by extracting a part of the original image. At the time of capturing, the size change part 5a cuts out a designated part of image data with a designated aspect ratio from the image data (called “full image”) output from the AFE part 4 to create the size-changed image. The aspect ratio of the full image is equal to the aspect ratio of the image pickup face of the image pickup device 3, and is generally a horizontally-long aspect ratio of 4:3. Hereinafter, the aspect ratio is shown by an expression format of “horizontal:vertical” unless otherwise specified.

At the time of playback, the size change part 5a likewise cuts out a designated region of a recorded image, read from the medium 8 and decompressed, at a designated aspect ratio to create a size-changed image. The size-changed image is also called “partial image” or “trimmed image”. The aspect ratio may be designated directly by a user or can be designated by using aspect information of a TV 21 which is acquired through HDMI (High-Definition Multimedia Interface) or the like when the camera 1 is connected to the TV 21 by the HDMI or the like.

The compression/decompression part 6 is provided with a still-image compression/decompression part 6a which performs compression and decompression for a still image in image-processed images and a move-image compression/decompression part 6b which likewise performs compression and decompression for a movie image. The still-image compression/decompression part 6a has a still-image compression/decompression circuit of JPEG (Joint Photographic Coding Experts Group) or the like. The move-image compression/decompression part 6b has a movie-image compression/decompression circuit of MPEG (Motion Picture Experts Group) or H.264. The recording/playback part 7 records compressed image data in the medium 8 as a recording medium at the time of shooting, and reads image data from the medium 8 at the time of playback. The medium 8 is a recording medium to save and record images.

The camera 1 is provided with a display control part 12, a display part 13 and an output part 14. The display control part 12 controls the display part 13 in such a way as to display an image recorded in the medium 8 at the time of playback, and display a monitor image with related information superimposed thereon at the time of shooting. The display part 13, which comprises, for example, an LCD (Liquid Crystal Display), displays a monitor image at the time of shooting and displays a decompressed recorded image at the time of playback. At the time of shooting, the user determines the composition and the shooting timing to perform a shooting operation while viewing the monitor image displayed on the display part 13.

The output part 14 converts a recorded image (full image) and a size-changed image, output from the image processing part 5, to an NTSC signal or a high-definition signal which matches with an external display device 21 to be connected, and outputs the converted signal. The external display device (hereinafter called “TV”) 21 is a TV of the NTSC type or a TV of the high-definition type.

The camera 1 is also provided with an MPU (microcontroller) 10, ROM 11 and an operation part 16. The MPU 10 is a control part that performs the general control of the camera 1, such as shooting and playback, according to a program. The ROM 11 is a non-volatile recordable memory comprising, for example, a flash ROM, where a control program for executing the control process of the camera 1 is stored. The operation part 16 notifies the MPU 10 of a camera user's instruction. As one example of the operation part 16, switches 16a, 16b and 16c are shown in FIG. 1. For example, the switch 16a is a release switch. The operation part 16 includes a switch for switching a shooting/playback mode and a switch for changing the shooting mode. The MPU 10 detects an instruction from the user for shooting, display or the like based on the action of the switch 16a, 16b, 16c.

The camera 1 is provided with a vertical/horizontal determination part 17 and a face detection part 15. The vertical/horizontal determination part 17 determines whether the posture (composition) of the camera 1 at the time of shooting is vertical or horizontal. Any one of an automatic determination method is available including one using a tilt sensor, one making determination in response to the camera user's instruction and one that determines the posture from the characteristic of an image at the time of playback. In the case the camera 1 detects the composition at the time of shooting, the MPU 10 writes the result of the vertical/horizontal-posture determination in shot image data. The result is reflected on the control of the AFE part 4 and the image processing part 5 by the MPU 10.

The face detection part 15 analyzes the captured image signal from the image signal according to the result of image processing on the monitor image at the time of shooting or the recorded image at the time of playback, detects if the image signal contains the eyes, nose, outline, etc. specific to the face, and outputs the size and position of the face in the screen to the MPU 10.

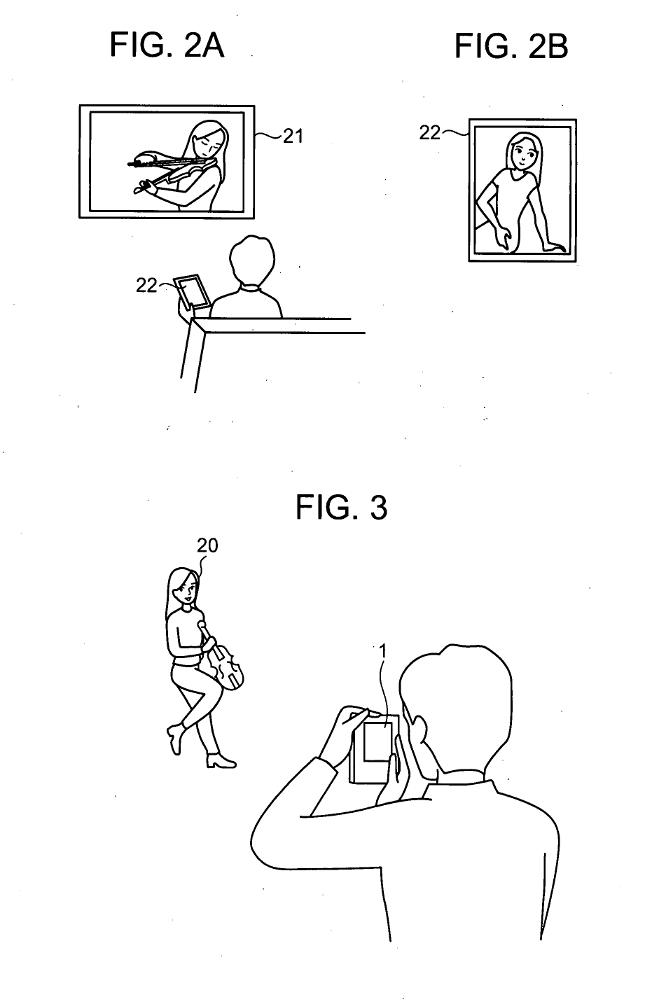

FIGS. 2A and 2B are diagrams showing one example of scenes where the user views images. As in conventional cases, the user often enjoys a shot image in the form of a print 22 (FIG. 2B). In addition, it is expected that the opportunities that the user enjoys shot image contents with the large-screen TV 21 will increase (FIG. 2A). Because the number of TVs 21 of the high-definition (HD) quality in use is increasing, the use of the horizontally-long aspect ratio of 16:9 for the TVs 21 will increase. As mentioned above, however, the image pickup devices of many cameras use the aspect ratio of 4:3 (the same for the print 22). The difference in aspect ratios between cameras and large-screen TVs brings about a problem.

FIG. 3 is a diagram showing a scene of shooting in a vertical composition. The subject 20 is shot by the camera 1 in the vertical composition.

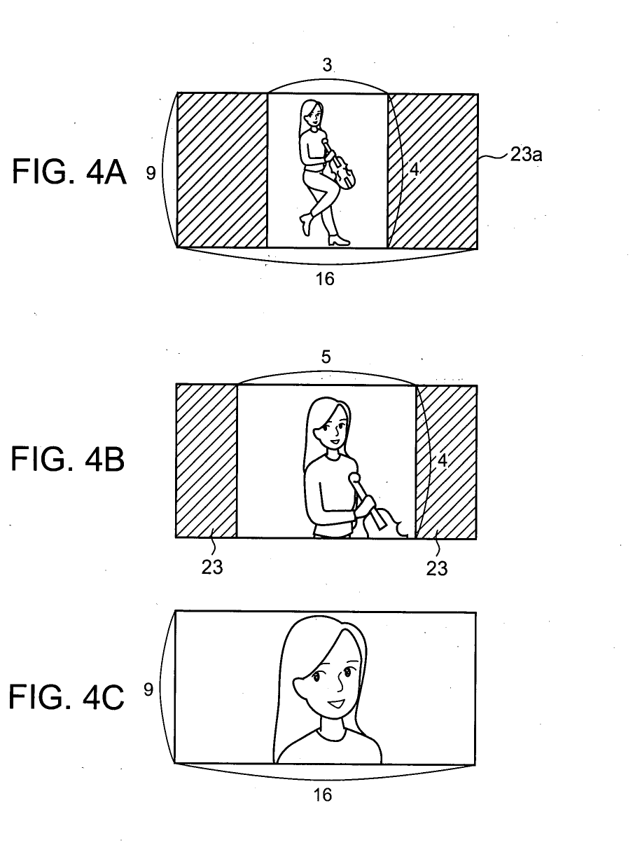

FIGS. 4A to 4C are diagrams showing various images to be displayed on a wide-screen TV 21 with the aspect ratio is 16:9. In shooting a person, a camera is frequently used in the vertical composition as shown in FIG. 3, and FIG. 4A shows an example of displaying an image shot in the vertical composition. When a vertically-long still image which has been shot for printing is reproduced on the screen of the TV 21, as shown in FIG. 4A, large non-display portions 23a appear on the right and left sides of the screen.

As an image of 3:4 is displayed on the screen of 16:9, the non-display portions 23a become large. For the screen of 16:9, the horizontal length for the actual image display is only 3×9/4=6.8 to the total length of 16, generating non-used portions. If two vertical images are shown side by side, the actual horizontal display length becomes 6.8×2=13.6<16 which is smaller than the full length of the TV. In any case, the poor efficiency of display is not negligible. It is desirable that the screen of the large-screen TV should be fully used to provide a powerful display. The display as shown in FIG. 4A would appear unsatisfactory for the large screen.

In this respect, according to the embodiment, images cut out so that the face of a subject appears on them are enlarged and are sequentially displayed in the order of FIG. 4A, FIG. 4B, FIG. 4C. The image of FIG. 4B is a size-changed image obtained by cutting out the original image of FIG. 4A around the upper half thereof with an aspect ratio of 5:4. The image of FIG. 4C is a size-changed image obtained by cutting out the original image of FIG. 4A in further enlargement around the face with the same aspect ratio of 16:9 as that of the TV 21. The size-changed image may be obtained by cutting out the original image recorded at the time of playback or may be pre-recorded together with the original image at the time of shooting. This type of display can provide an effective screen display.

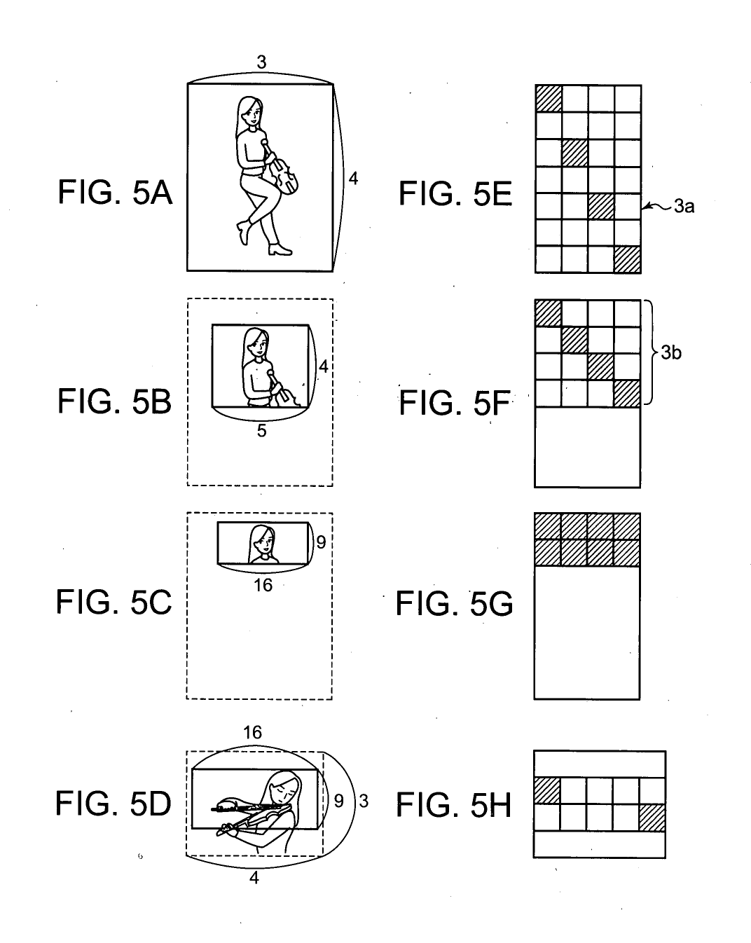

FIGS. 5A to 5H are diagrams showing the relationships between the sizes of images to be displayed on the screen of the TV 21 and pixels to be used in displaying the corresponding images. The images of FIGS. 5A, 5B and 5C respectively correspond to the images of FIGS. 4A, 4B and 4C. In FIGS. 5B to 5D, the broken-line frames indicate the range of the full image or the original shot image, while the solid-line frames indicate the range of a size-changed image to be displayed on the TV 21.

FIGS. 5E to 5H are conceptual diagrams showing a part of a pixel map of image data, with one segment representing one pixel, and show the thinned readout ratio at the time of playback. FIGS. 5E to 5H respectively correspond to the images of FIGS. 5A to 5D. Note that the read pixel ratios to be discussed below are just examples.

The number of pixels of the full image as a still image is often selected to be the number of full pixels (e.g., 10 million pixels) of the image pickup device to meet a demand that the still image should provide a satisfactory print. The aspect ratio and the number of reproducible pixels of the TV 21 are both considerably smaller than those of the image pickup device. For example, the TV 21 of full high-definition has 1080×1820 pixels (about two million pixels) significantly smaller than the number of reproducible pixels of the image pickup device, so that an image output to the TV 21 from the output part 14 needs fewer pixels, resulting in a shorter transmission time. When the output image is a full image as shown in FIG. 5A, for example, the image processing part 5 performs an interpolation process of extracting the pixels at the pixel ratio (one out of every eight pixels) indicated by hatched lines as shown in FIG. 5E. That is, it is efficient to output an image the number of whose pixels is reduced to the minimum necessary number according to the playback performance of the TV 21.

The image of FIG. 5B shows the upper half portion of the full image enlarged. In a case of displaying an image as shown in FIG. 5B, the size change part 5a creates the image by reducing the thinning ratio in consideration of enlargement, at the time of cutting out a predetermined range from the full image. That is, because the display area of the TV 21 increases, the ratio of the pixels to be used to the full pixels is increased as shown in FIG. 4B. For example, one pixel out of every four pixels of the full image data is used as shown in FIG. 5F. This is because if the image of FIG. 5A which has been thinned greatly is enlarged directly, a rough screen is merely reproducible even when the TV 21 has a high-definition display capability or the full image has abundant information.

FIG. 5C shows a further enlarged image. FIG. 5C shows a facial area of the full image, whose aspect ratio is the same as the aspect ratio of 16:9 of the TV 21. The size change part 5a also makes the number of pixels to be used greater than those in FIG. 5A and FIG. 5B. For example, all the pixels of the full image are used as shown in FIG. 5G. As the thinning ratio is changed according to the size of a cut-out image, the high-definition performance on the screen is maintained.

The above-described example illustrates a vertical composition whose display area significantly differs from that of the wide-screen TV of 16:9. FIG. 5D shows an example where an image (4:3) shot in the normal horizontal composition is displayed on the TV 21. In this case, only the solid-line area in FIG. 5D (16:9) is displayable so that it is necessary to display a limited area as indicated by the solid lines. The thinning ratio used in this case is the ratio shown in FIG. 5H (one pixel out of every four pixels). The above process can ensure the full use of the playback performance of the TV 21 to allow the user to enjoy a beautiful high-definition image.

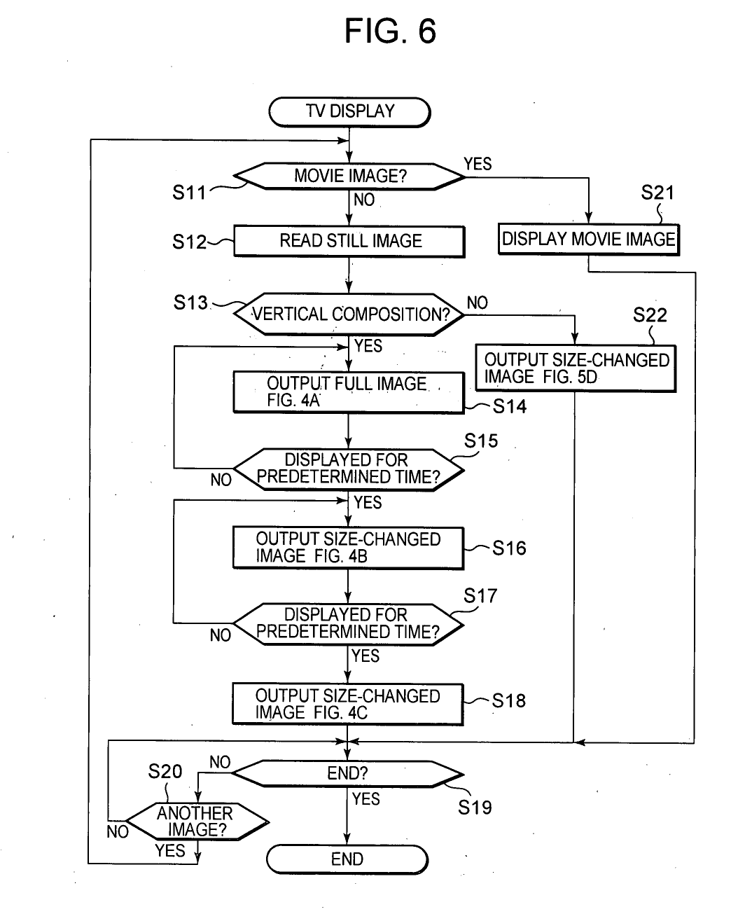

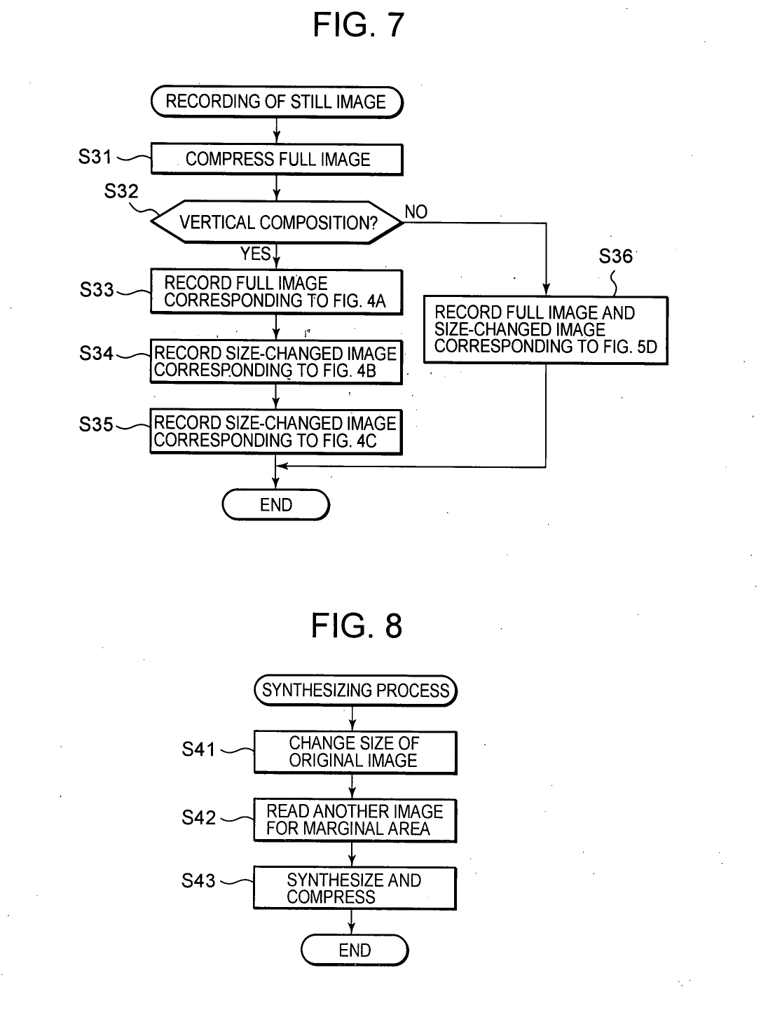

FIG. 6 is a flowchart illustrating procedures of an image output process which creates size-changed data at the time of playback. This image output process is executed mainly by the MPU 10, the image processing part 5, the size change part 5a and the output part 14 according to the program.

First, it is determined whether an image to be reproduced is a movie image or a still image (step S11). In the case of a movie image (step S11: YES), an output process for displaying a movie image is executed (step S21). When it is determined that the image is a still image (step S11: NO), still image data is read from the medium 8 via the recording/playback part 7 (step S12). Next, it is determined whether the shooting composition is vertical or horizontal (step S13). The vertical/horizontal determination part 17 makes the determination on the vertical/horizontal composition based on vertical/horizontal data attached to the image data at the time of shooting. If there is no vertical/horizontal data, the determination may be made based on the characteristics of the image by the image processing part 5 at the time of playback.

The size change part 5a executes the following size changing process based on the result of the vertical/horizontal composition determination, and the output part 14 outputs the image to the TV 21. This is the process which has been explained referring to FIGS. 4A-4C and FIGS. 5A-5H. First, when the shooting composition is not the vertical composition (step S13: NO), i.e., when the screen is the normal horizontal screen, the size change part 5a cuts out the area indicated by the solid lines in FIG. 5D according to the aspect ratio of the connected TV 21, and the output part 14 converts the size-changed image to a TV signal to be output (step S22).

The output image is displayed on the TV 21. It is assumed in the following description that the image is output to the TV with the aspect ratio is 16:9. With regard to the aspect ratio, aspect ratio information sent from the TV 21 may be used, if there is any. If there is no aspect ratio information sent from the TV 21, the aspect ratio may be set according to the user's instruction.

In the case of a photo of the vertical composition (step S13: YES), such a display as to sequentially repeat the images as shown in FIG. 4A, FIG. 4B, FIG. 4C in a given time is executed. This display is carried out to prevent the images from being changed drastically. The image processing part 5 changes the vertical/horizontal orientation of the read image data before outputting the image data as the full image as shown in FIG. 4A (step S14). This aspect ratio (horizontal:vertical) remains 3:4. When the image has been displayed for a predetermined time (step S15: YES), the image is changed to an image with the size as shown in FIG. 4B. The size change part 5a changes the aspect ratio to 5:4 from the read full image, sets an area equivalent to the upper half portion of the subject based on the face detected information, cuts out the area (trimming), and outputs the cut-out image (step S16). The MPU 10 automatically sets the aspect ratio of 5:4 from the aspect ratio of the TV 21, and notifies the size change part 5a of the aspect ratio.

When the image is further displayed for a predetermined time (step S17: YES), the image is changed to an image with the size as shown in FIG. 4C. The size change part 5a changes the aspect ratio to 16:9, sets an area including the face based on the face detected information, cuts out the area from the full image (trimming), and outputs the cut-out image (step S18).

When there is a termination instructing operation during image display as shown in FIG. 4C (step S20: YES), the flow returns to step S11. The display order at the time of playback is not limited to the order of FIG. 4A, FIG. 4B, and FIG. 4C, but may be in the reverse order of FIG. 4C, FIG. 4B, and FIG. 4A. As a movie image and a still image are recorded as an image file in the medium of the camera, it is determined whether the user's operation to change an image file specifies a movie image or a still image and the display method is then changed according to the determination result. Although only an image with an aspect ratio of 5:4 is shown in the flowchart as an image with an aspect ratio lying between 3:4 and 16:9, the intermediate aspect ratio may of course be finely set to include other aspect ratios. For example, three intermediate aspect ratios may be set between 3:4 and 16:9 to provide a total of five aspect ratios of 3:4, 4:4, 5:4, 6:4 and 16:9.

The image output process is executed by other parts than the imaging system (lens part 2, image pickup device 3, AFE part 4) of the camera 1. The unit comprising the MPU 10, the image processing part 5, the size change part 5a, the face detection part 15, the recording/playback part 7, the output part 14 and the like is also a constituting element of the invention. This unit is called an image output apparatus.

The foregoing description has been given of the case of creating a size-changed image at the time of playback and outputting the size-changed image to the display device. This case is not restrictive, and the size-changed image may be created and recorded at the same time as the time of shooting. The latter case will be described below.

FIG. 7 is a flowchart illustrating procedures of an image recording process of also recording a size-changed image at the time of shooting. This process is executed mainly by the MPU 10, the image processing part 5 and the size change part 5a according to the program.

A shot original image is stored in a temporary memory (not shown). Then, the stored original image is compressed as a full-pixel image or a many-pixel image which can provide a satisfactory print (step S31). Next, the process is changed depending on whether the shot image has a vertical composition or not. The vertical/horizontal determination part 17 determines if the composition is the vertical composition (step S32). When it is not the vertical composition (step S32: NO) but the horizontal composition, the size change part 5a creates a horizontally-long size-changed image as indicated by the solid lines in FIG. 5D from the uncompressed original image stored in the temporary memory, and the recording/playback part 7 records the size-changed image together with the original image in the medium 8 (step S36).

When it is the vertical composition (step S32: YES), on the other hand, the compressed original image which is an image showing the entire subject image as shown in FIG. 4A is record in the medium 8 by the recording/playback part 7 (step S33). Subsequently, the size change part 5a creates an intermediate image as shown in FIG. 4B with the changed aspect ratio (5:4) from the original shot image, and the recording/playback part 7 records the image (step S34). The MPU 10 determines the aspect ratio from the aspect ratios of the image pickup device 3 and the TV 21. Further, the size change part 5a creates an image with an aspect ratio of 16:9 which effectively uses the entire TV screen as shown in FIG. 4C from the shot image, and the recording/playback part 7 records the image (step S35).

Although images are recorded in three steps in such a way as to switch the images in three steps before being displayed, the images may be recorded in two steps as in step S33 and step S35. This is because an intermediate image which is viewed less may be created from the image in the first step by electronic zooming at the time of playback.

Because a size-changed image is recorded at the time of shooting as mentioned above, it does not require the process of variously changing the size of an image of full pixels and displaying the size-changed images every time playback is performed, thus eliminating the need for a special circuit for the process on the playback side. Although three sizes are shown in the above-described example, the image size may of course be changed to more than three sizes.

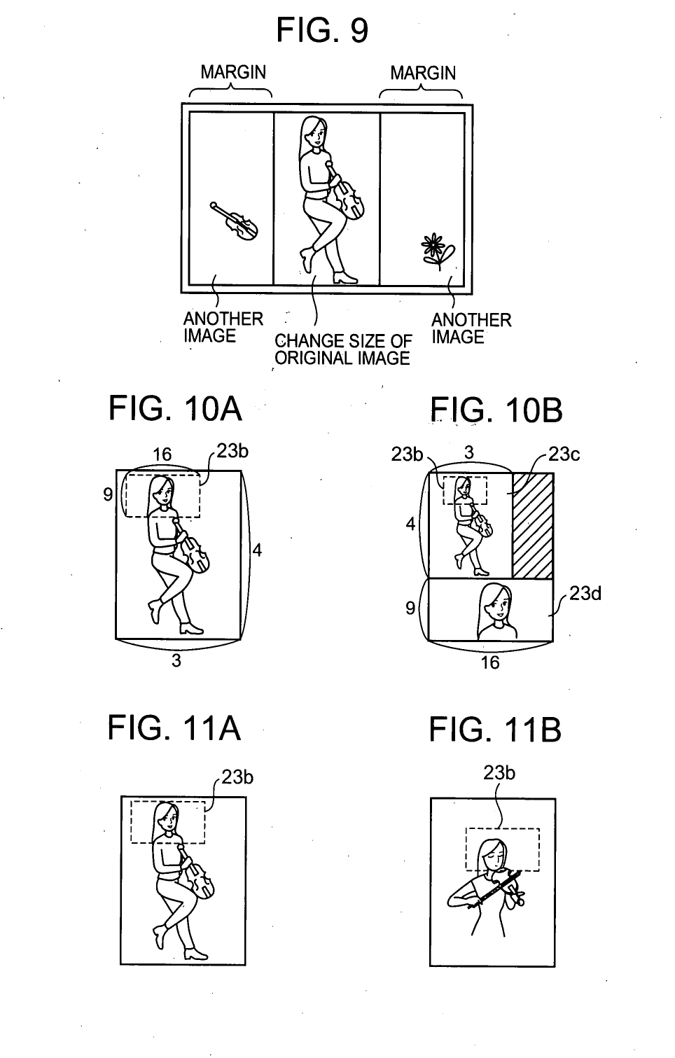

A modification of the first embodiment will now be described referring to FIGS. 8 and 9. When a screen with both sides shown in complete image-less black as shown in FIG. 4A, the image may appear poor. In the modification, therefore, the marginal portions are effectively used at the time of displaying an image at the time of playback. FIG. 8 is a flowchart illustrating procedures of the image synthesizing process. FIG. 9 is a diagram showing an image to be displayed on the TV 21.

In this modification, a synthesized image having another image attached to either side of the screen (FIG. 9). It is however desirable that those images to be attached should not interfere with the current image viewing. That is, an image which is too troublesome or is not so comprehensible is not suitable as another image to be attached. For example, a shot image or a simplified or abstracted image like an illustration acquired from a shot image or a reduced part thereof is desirable as another image to be attached. Illustrated images may be prerecorded in the camera and used as another image.

The procedures of the image synthesizing process will be explained along the flowchart in FIG. 8. Original shot image data record in the medium 8 is read out and decompressed. The size change part 5a performs the size changing process on the original image (step S41). Of other images recorded in the medium 8 or the ROM 11, an image designated by the user or automatically selected is read out as another image to be used in a marginal area and decompressed (step S42). The image processing part 5 synthesizes the another image with the original image subjected to the size changing process to create a synthesized image, the still-image compression/decompression part 6a compresses the synthesized image, and the recording/playback part 7 records the synthesized image in the medium 8 (step S43). When the user gives a display instruction, the synthesized image is read out and displayed on the TV 21. The above-described process can allow the wide screen to be used more effectively and ensure effective display.

### Second Embodiment

The second embodiment will now be described referring to FIGS. 10A to 12. According to the second embodiment, at the time of shooting an enlarged portion at the time of playback on a TV, a portion of a face image is detected and is taken into account in the shooting. This is because the face of a person is generally important in a vertically-long image, particularly, a portrait photo, so that it is effective to shoot or display the facial portion in zoom as shown in FIG. 4C. As the block diagram of the camera to which the invention is adapted is the same as that in FIG. 1, the detailed description thereof is omitted. The aspect ratios of the image pickup device and the TV 21 on which the image is to be displayed are also 4:3 and 16:9.

FIGS. 10A and 10B are diagrams showing two examples of a monitor image to be displayed on the display part 13 at the time of shooting in vertical composition. The screen of FIG. 10A shows the full image and information indicating that area which is to be recorded in enlargement. The display control part 12 displays a frame 23b at the upper portion of the screen as information indicating an area which is to be recorded in enlargement. The area in the frame 23b is enlarged as shown in FIG. 4C. The aspect ratio of the frame 23b is 16:9 to match with that of the TV 21.

The screen of FIG. 10B shows an example of a multi-display. A shot image (full image) 23c for a still image and a size-changed image 23d to be used for display on the TV 21 are multi-displayed on the display part 13. The aspect ratio of the size-changed image 23d is 16:9. The full image and the size-changed image are displayed at the same time, which is convenient in shooting an image. At this time, the portion to be enlarged at the time of displaying the image on the TV 21 may further be indicated with a frame 23b. The position of the frame 23b may be shifted as the user operates a corresponding switch or the like. Further, it is more desirable that the apparatus is configured in such a way that the position of the frame 23b once set automatically follows the movements of the face using the face detecting technique when the position of the face changes.

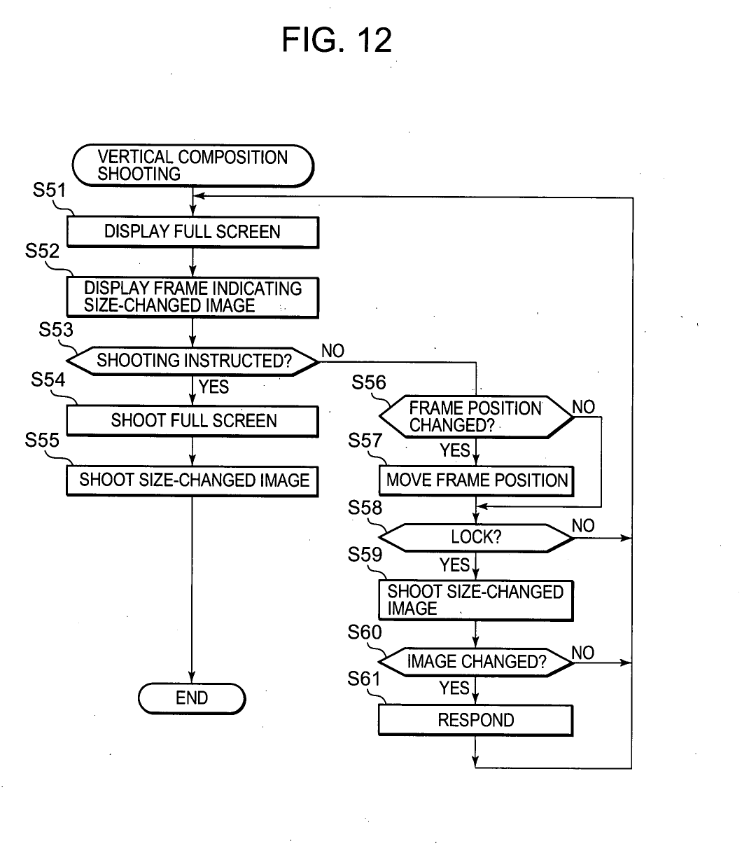

FIG. 12 is a flowchart illustrating procedures of a shooting process relating to with the monitor image. For easier understanding, the following description will be given of the case of shooting an image in vertical composition. This process is executed mainly by the MPU 10, the image processing part 5, the size change part 5a and the display control part 12 according to the program.

First, a full image is displayed on the display part 13 (step S51) to determine a decisive moment or a composition. The frame 23b as information indicating an area in the size-changed screen to be displayed on the screen of the TV is also displayed (step S52). That is, an image as shown in FIG. 10A is displayed. Of course, the multi-display as in FIG. 10B may be used instead.

The flow waits for a shooting instruction made by the user (step S53). The user who has decided that the timing and current composition are adequate operates the release switch (e.g., switch 16a). When the release instruction is made (step S53: YES), a still image equivalent to a full screen (full image) is shot (step S54). Then, an image within the area indicated by the frame 23b in step S52 is shot (step S55). In the shooting in step S55, the image whose size has been changed by the size change part 5a to the one matching with the playback performance of the TV 21 is recorded. Accordingly, when the TV 21 is used, the screen shown in FIG. 4A and the screen shown in FIG. 4C can be switched from one to the other, or the transition between the two can be done automatically to enjoy the image.

If the user does not like the position of the frame 23b, the user can change the position before shooting by operating the XY direction keys belonging to the operation part 16. The user's position changing operation specified by the XY direction keys is determined (step S56). When the user has performed the operation to change the position of the frame 23b (step S56: YES), the position of the frame 23b is shifted (step S57). When this changing operation is not performed (step S56: NO), the flow jumps to step S58. When the user performs an operation to lock the frame 23b at that position (step S58: YES), the image in the frame 23b is stored (step S59). Then, even if the direction of the camera is changed to change the position of the image in the frame 23b (step S60: YES), the position of the previous image in the frame 23b in the screen is detected and the current position of the frame 23b is shifted to that position (step S61). The follow-up movement of the position of the frame 23b is executed based on, for example, the detection done by the face detection part 15. If there is no lock operation (step S58: NO) or no image change (step S60: NO), the flow returns to step 51.

FIGS. 11A and 11B are diagrams showing an example of the movement of the frame 23b. If the frame 23b is set to move following the change on the image, the frame 23b moves to a position where a similar image is present, even when the composition is changed from the one in FIG. 11A to the one in FIG. 11B. The camera 1 determines a position of the target image and changes the position of the size-changed image accordingly without requiring the user's instruction for changing the frame position every time, so the user can concentrate on shooting the image.

According to the second embodiment, as described above, image shooting can be carried out while the user can observe an image, which is enlarged and displayed on TV later, on the monitor.

According to the embodiments, the user can shoot an image with knowing the way the image will be presented on a print format and large-screen TV format later. Although the foregoing descriptions of the embodiments have been given of the case where the aspect ratio of the TV 21 differs from the aspect ratio of the image pickup device 3 of the camera, the invention is not limited to this case. Even with the same aspect ratio, if the image is shot in vertical composition, it is effective to display a size-changed image with a changed aspect ratio and enlarged size.

A part or all of the processes of the MPU 10 explained in the descriptions of the embodiments may also be realized by hardware. The face detection part 15 and the vertical/horizontal determination part 17 or the like may also be realized by software. The specific configurations are the matter of design choice. The control processes to be executed by the MPU 10 are achieved by the software program stored in the ROM 11 and supplied to and performed on the MPU 10. Therefore, the software program itself realizes the described functions of the MPU 10, and the recording medium storing the program falls in the scope of the invention. Variety kind of recording mediums are available. For example, an optical recording medium, such as a CD-ROM or DVD, a magnetic recording medium like MD, a tape medium, and a semiconductor memory like an IC card can be used as well as a flash memory. Although the descriptions of the embodiments have been given of the case where the invention is adapted to a digital camera, the case is not restrictive and the invention may be adapted to the camera part of a cellular phone.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. A camera comprising:
an output part that outputs a recorded image to an external display device;
an image pickup device that captures a subject image;
a size change part that creates a size-changed image which is a partial image of a full image whose captured area is an entire capturing face of the image pickup device according to a difference between an aspect ratio of the full image and an aspect ratio of the external display device; and
a control part that controls to record the full image and the size-changed image.

2. The camera according to claim 1, wherein the size change part creates the size-changed image by applying an aspect ratio reflected the posture of the camera of the shooting time to the full image.

3. The camera according to claim 1, further comprising:
a display part that displays an image captured by the image pickup device as a monitor image at a time of shooting; and
a display control part that displays regional information indicating a region of the size-changed image created by the size change part on the monitor image.

4. The camera according to claim 3, further comprising a face detection part that detects a face of the subject,
wherein the display control part moves and displays the regional information according to a change in a face position on the full image.

5. The camera according to claim 1, further comprising:
a display part that displays an image; and
a display control part that displays the full image and the size-changed image in respective areas on the display part.

6. An image output apparatus that outputs an image to an external display device, comprising:
a size change part that creates a size-changed image which has an aspect ratio according to the external display device, from a part of a recorded captured image; and
a control part that controls to output the size-changed image and the recorded shot image to the external display device.

7. The image output apparatus according to claim 6, wherein the size change part creates a plurality of size-changed images by changing the aspect ratio in a stepwise manner, and
the control part controls to sequentially output the plurality of size-changed images.

8. The image output apparatus according to claim 6, further comprising a vertical/horizontal determination part that determines whether a posture of a camera at a time of capturing is vertical or horizontal,
wherein when the recorded shot image is shot vertically, the size change part creates a size-changed image with an aspect ratio according to a horizontally-long aspect ratio of the external display device with the captured image being set in a vertical orientation.

9. An image recording method for a camera that outputs a captured image recorded on a recording medium to an external display device, comprising:
creating a size-changed image whose size is changed with an aspect ratio different from that of the captured image, from a part of the captured image output from an image pickup device; and
recording the size-changed image together with the captured image, as an image to be output to the external display device.

10. An image output method that outputs an image to an external display device, comprising:
creating a size-changed image which has an aspect ratio corresponding to the external display device and different from an aspect ratio of a recorded image by cutting out a part of the recorded image; and
outputting the size-changed image and the recorded image to the external display device.

11. A recording medium storing a program that makes a computer to execute a process of outputting an image to an external display device, the program allowing the computer to:
create a size-changed image which has an aspect ratio corresponding to the external display device and different from an aspect ratio of a recorded image by cutting out a part of the recorded image; and
output the size-changed image and the recorded image to the external display device.

12. A camera capable of outputting image data to an external display device, comprising:
an image pickup device that captures a subject image;
a face detection part that detects a face portion of a subject from an image captured by the image pickup device;
a size change part that creates an image with a same aspect ratio as that of the external display device by cutting out a part of the image captured by the image pickup device in such a way as to include the face portion detected by the face detection part; and
an output part that outputs the image created by the size change part to the external display device.

13. The camera according to claim 12, further comprising a display part that displays an image captured by the image pickup device, wherein the display part can simultaneously display a full-area image captured by the image pickup device and the image created by the size change part.

14. The camera according to claim 13, wherein regional information indicating a region of the image created by the size change part is displayed on the full-area image captured by the image pickup device and displayed through the display part.

15. The camera according to claim 12, wherein a cutout region of the size change part automatically changes in response to movement of the subject using a detection result from the face detection part.

16. The camera according to claim 12, wherein the size change part creates a plurality of images with different cutout regions, and
the output part sequentially outputs a full-area image captured by the image pickup device and the plurality of images created by the size change part to the external display device.
